(19) United States
(12) Patent Application Publication
(10) Pub. No.: US 2025/0229224 A1
(43) Pub. Date: Jul. 17, 2025

(54) PROCESS FOR REDUCING FOSSIL CO2 EMISSIONS

(71) Applicant: PAUL WURTH S.A., Luxembourg (LU)

(72) Inventors: Luca SPADONI, Genova (IT); Lorenzo MICHELETTI, Castagneto Carducci (Livorno) (IT); Alessandro OLCESE, Chiavari (IT); Davide FOSSATI, Genova (IT); Francesco VENEZIANO, Rapallo (Genova) (IT); Ismael MATINO, Pisa (IT); Antonella ZACCARA, San Giuliano Terme (IT); Alice PETRUCCIANI, Casola in Lunigiana (IT); Valentina COLLA, San Giuliano Terme (IT); Teresa Annunziata BRANCA, Pisa (IT)

(21) Appl. No.: 18/852,630

(22) PCT Filed: Mar. 29, 2023
(86) PCT No.: PCT/EP2023/058163

§ 371 Date: Sep. 30, 2024

(30) Foreign Application Priority Data
Mar. 29, 2022 (LU) LU501739

(51) Int. Cl. B01D 53/79; B01D 53/14; B01D 53/18; B01D 53/54; B01D 53/68; B01D 53/78; B01D 53/96; B01F 27/90; B01F 35/00; B01F 101/00; C21B 7/00; F27D 17/10; F27D 17/22

(52) U.S. Cl. CPC B01D 53/79; B01D 53/1425; B01D 53/185; B01D 53/54; B01D 53/68; B01D 53/78; B01D 53/96; B01F 27/90; B01F 35/55; C21B 7/002; F27D 17/10; F27D 17/22; B01D 2251/304; B01D 2251/604; B01D 2252/103; B01D 2257/2045; B01D 2257/408; B01D 2258/025; B01D 2258/0283; B01F 2101/2204; B01F 2215/0422; B01F 2215/0477; B01F 2215/0481; C21B 2100/40

(57) ABSTRACT

A process for operating an oxidizable combustion gas cleaning unit in a metallurgical plant, including the steps of: (a) passing an oxidizable combustion gas from a metallurgical reactor, in particular a blast furnace gas from a blast furnace, in a packed bed scrubber arrangement through a packed bed in countercurrent with a washing water or in a spray scrubber arrangement to remove cyanide compounds, in particular hydrogen cyanide, and to increase the removal of chloride compounds, in particular hydrogen chloride, from the combustion gas by solubilizing the cyanide and chloride compounds in the washing water, (b) collecting the washing water containing solubilized cyanide and chloride compounds at a bottom end of the packed bed or spray scrubber arrangement, and (c) collecting a cleaned oxidizable combustion gas at a top of the packed bed or spray scrubber arrangement, wherein a base is added to the washing water before step (a).

### TECHNICAL FIELD

The present disclosure generally relates to the operation of a metallurgical plant and in particular to a process which allows reducing fossil CO₂ emissions.

### BACKGROUND

The major amount of the CO₂ released into the atmosphere today comes from the combustion of fossil fuel. The iron and steel industry is among the biggest industrial emitters of greenhouse gases, especially CO₂, accounting for 4%-7% of anthropogenic CO₂ emissions globally. Even though in the past 40 years the European steelmaking industry reduced its energy consumption of about 50%, further reductions are desirable from an environmental and economic points of view and increasingly legally mandatory.

The references “Best Available Techniques” (BAT) for Iron and Steel and their conclusions are the most important references for health and environmental limits applied by all European countries in their legislations.

As an example, according to the European regulation on the European Trading Scheme (ETS, directive 2003/87/CE), a cap and trade mechanism, the avoided CO₂ emissions represent CO₂ allowances which can be sold to other companies. In this way, the decrease of the CO₂ emissions, besides a positive effect on the climate, results in a decrease of the expenses or an increase of the earnings.

Since most actors are facing severe problems to be compliant with the mentioned regulation, this issue is very important in order to avoid undesired consequences on proper plant operation. Moreover, all health and environment topics are expected to be increasingly crucial in the future, both in most advanced countries and in newly industrialized and developing ones. In fact, some restrictions are going to be implemented even in important steel producing countries outside the EU (ref. for example to Zero Liquid Discharge foreseen in MOEF draft, India, dated Mar. 18, 2016).

### BRIEF SUMMARY

The present disclosure proposes a process for operating at least part of a metallurgical plant in a way allowing the reduction of fossil CO₂ emissions.

More specifically, the present disclosure proposes, in a first aspect, a process for operating an oxidizable combustion gas cleaning unit in a metallurgical plant, comprising the steps of:
(a) passing an oxidizable combustion gas from a metallurgical reactor, in particular a blast furnace gas from a blast furnace, in a packed bed scrubber arrangement through a packed bed in counter-current with a washing water or in a spray scrubber arrangement to remove cyanide compounds, in particular hydrogen cyanide, and to increase the removal of chloride compounds, in particular hydrogen chloride, from said combustion gas by solubilizing said cyanide and chloride compounds in said washing water,
(b) collecting the washing water containing solubilized cyanide and chloride compounds at a bottom of the packed bed or spray scrubber arrangement, and
(c) collecting a cleaned oxidizable combustion gas at a top of the packed bed or spray scrubber arrangement,
   wherein a base is added to the washing water before step (a), said base being preferably chosen among oxides and hydroxides of alkali metals and alkaline earth metals, in particular among NaOH, KOH, Ca(OH)₂ or mixtures thereof, most preferably the base is NaOH, which is added between 3.5% and 6.5%, preferably between 4.5% and 5.5%, above the stoichiometric amount with respect to the cyanide and chloride compounds, in particular hydrogen cyanide and hydrogen chloride, to be removed from the oxidizable combustion gas.

The inventors have found that by reducing the contents of cyanide compounds, in particular hydrogen cyanide, in an oxidizable combustion gas from metallurgical reactors, such as blast furnace gas, prior to using them in a hot blast stove unit for hot blast generation allows heating the blast at higher temperatures without exceeding allowable NOx contents at the chimney when the so combusted gas is released to the atmosphere. Higher hot blast temperatures will result in a significant reduction in fuel/coke consumption within the metallurgical reactor. The inventors estimate that, depending on average cyanide compounds in the blast furnace gas, an increase up to 150° C. can be achieved in operating an otherwise identical metallurgical plant with the process of the disclosure. Realizing that every increase of 10° C. allows decreasing the coke rate by approximately 1 kg/t of hot metal, an overall fossil CO₂ emission reduction up to 48 kg CO₂/tonne hot metal can be achieved without compromising the proper operation of the metallurgical reactor. The advantage of reducing cyanide compounds from the blast furnace gas can also be of benefit for other processes wherein blast furnace gas is used as fuel for combustion.

Moreover, the removal of the cyanide compounds before combustion in the hot blast stove unit allows for a more flexible control of the hot blast generation by taking into account varying contents of nitrogen sources in the fuel fed to the metallurgical reactor. Cyanide compounds in the context of the disclosure stem from the fossil fuel used in the metallurgical reactor or are formed during the metallurgical process from nitrogen including compounds contained within said fuel. Cyanide compounds can be inorganic or organic. Inorganic compounds may be simple (e.g. HCN, KCN) or even complexed by metal species.

The publication “Removal of cyanides from blast-furnace gas and wastewater” Steel in translation, Allerton Press, Inc, Heidelberg, vol. 42, no. 7, pages 606-610; 26 Oct. 2012, describes a method to treat and clean blast furnace gas, by removing cyanides compounds that are formed inside the blast furnace. The blast furnace gas is treated through a wet scrubber that is able to remove solid cyanide species, such as salts, by dissolution in water. The resulting washing water is treated with ozone to avoid side reactions between the solubilized cyanides, CN⁻, and the acidic components present in the blast furnace gas that may dissolve in water such as CO₂. However, contrary to the present disclosure, the method disclosed in this publication does not allow for significantly capturing gaseous HCN already present in the blast furnace gas, nor does it allow for effectively preventing gaseous HCN from reforming within the wastewater.

Besides the cyanide compounds removal, an increased removal of chloride compounds, such as hydrogen chloride, from the oxidizable combustion gas is obtained with the proposed scrubber. Hydrogen chloride derives from the coal combustion and it is partially removed in the common cleaning system of the oxidizable combustion gas, generally devoted to dust removal. However, an increased removal is desirable to decrease the corrosion of the equipment crossed by the said gas.

In the context of the disclosure, two scrubber arrangements can be applied: packed bed or spray.

The packed bed scrubber arrangement generally comprises a column containing one or more layers of variously-shaped packing material, such as Raschig rings, spiral rings, Berl saddles, etc., that provide a large surface area for liquid-gas contact. The bed packing(s) may be held in place by wire mesh retainers and are generally supported by at least one plate near the bottom of the scrubber arrangement. Washing water is evenly introduced above the bed packing and flows down through the bed. The washing water coats the packing and establishes a thin film providing exchange surface for cyanide and chloride compounds dissolution. Advantageously, the packed bed scrubber arrangement contains one or more intermediate plates defining a redistribution zone without packing bed, thereby dividing the packed bed into a plurality of superposed packed bed zones, where the film of washing water is forced to drip off and redistribute to the next packed bed.

The spray scrubber arrangement generally includes a column with different spray stages having different number and configurations of nozzles distributed on ramps. In particular, nozzles dimensions, numbers and configurations guarantee the following needs: a suitable dimension of droplets allowing a high gas/liquid surface area, a compromise between spray overlapping and water losses on the spray column wall and higher amount of washing water in the spray stages nearest at the inlet of the gas to be treated which is richer of hydrogen cyanide and of hydrogen chloride. Droplets of washing water in contact with gas are able to absorb cyanide and chloride compounds. The multistage configuration allows an independent management of each stage depending on the amount of cyanides and chlorides to be removed.

In both scrubber arrangements, the oxidizable combustion gas flows up the column, i.e. in countercurrent to the washing water flowing down by gravity. Moreover, a demister at the top of the column is recommended in order to abate entrained droplets.

In advantageous embodiments, the packed bed scrubber arrangement useable in the process of the disclosure comprises, a column including a random packed bed unit, optionally comprising a plurality of packed bed zones separated by redistribution zones, the packed bed unit being supported by at least one perforated support plate, a washing water spray distributor arranged above said packed bed for distributing the washing water into the packed bed unit, a washing water collecting unit arranged at the bottom end of the packed bed scrubber arrangement below the packed bed, said washing water collecting unit comprising a duct for draining the washing water containing cyanide and chloride compounds from the packed bed scrubber arrangement, a gas feeding unit arranged for feeding the oxidizable combustion gas into the column below the packed bed unit, and an oxidizable combustion gas discharge unit on the top of the packed bed column comprising a duct for discharging the cleaned oxidizable combustion gas and preferably placed after a mist eliminator.

In some embodiments, the packed bed scrubber arrangement is configured such that the washing water to oxidizable combustion gas ratio in the packed bed (comprising all packed bed zones in case of one or more redistribution zone(s)) in step (a) is between 3.5 and 6.5 L/Nm³, preferably said ratio is between 4.5 and 5.5 L/Nm³, most preferably said ratio is approximately 5.1 L/Nm³.

In some embodiments, the packed scrubber arrangement is configured such that the mean residence time of the combustion gas in the packed bed in step (a) is between 3.4 and 5.8 s, preferably between 4.1 and 5.1 s. The mean residence time has its usual meaning in the field and represents the average duration of time during which a determined quantity of gas needs to flow from the bottom of the packed bed unit to its top.

In some embodiments, the packed scrubber arrangement is configured such that the packed bed has a total (wet) contact surface, i.e. the total surface of the (wet) packed bed can be in contact with the oxidizable combustion gas, between 0.09 and 0.15 m²/(Nm³/h), preferably between 0.11 and 0.13 m²/(Nm³/h).

The packed bed scrubber arrangement is operated at near atmospheric pressure, such as at 0.02 to 0.2 barg, preferably between 0.06 to 0.1 barg. The temperature inside the packed bed is well below the water boiling temperature, preferably between ambient temperature and 70° C., in particular between 35 and 55° C. The packed bed scrubber arrangement can also be operated at a higher pressure (up to 2.5 barg) and at higher temperature.

In advantageous embodiments, the spray scrubber arrangement useable in the process of the disclosure comprises a column including at least four independent spray stages distributed along the height of the column and composed of a set of nozzle units located on multiple ramps and distributing of the washing water in the form of suitable droplets, said globally spray section unit, a gas feeding unit arranged for feeding the oxidizable combustion gas into the column below spray section unit and preceded by a by-pass, external to the column unit, in order to regulate the flow amount of oxidizable combustion gas going to the hot stoves to be treated in the spray scrubber, a washing water collecting unit arranged at the bottom end of the spray scrubber arrangement below the spray section unit and the gas feeding unit, said washing water reservoir unit comprising a duct for draining the washing water containing cyanide and chloride compounds from the spray scrubber arrangement, and an oxidizable combustion gas discharge unit on the top of the spray column comprising a duct for discharging the cleaned oxidizable combustion gas and placed after a mist eliminator.

In some embodiments, the spray scrubber arrangement is configured such that the globally exploited washing water, namely the sum of all the washing water distributed in the different spray stages, to oxidizable combustion gas ratio in step (a) is between 0.8 and 2.9 L/Nm³, depending on the amount of cyanide and chlorides to be removed and on the desired removal and in order to manage the concentration of cyanides and chlorides in the washing water. The preferred value of that ratio is between 1.3 and 1.5 L/Nm³.

In some embodiments, the spray scrubber arrangement is designed such that the mean residence time of the combustion gas in the spray section unit in step (a) is between 2 and 8 s, preferably between 3 and 4 s. The high variation depends on the amount of oxidizable combustion gas to be treated time by time and on its temperature; in more common conditions residence time is comprised in the second range (3-4 s). The mean residence time has its usual meaning in the field and represents the average duration of time during which a determined quantity of gas needs to flow from the bottom of the spray section unit to its top.

In some embodiments, the nozzles of the spray scrubber arrangements are axial flow full cone nozzles providing droplets having a Sauter mean diameter between 1100 and 1150 μm through a proper setup of the nozzle pressure.

The spray scrubber arrangement is operated at near atmospheric pressure, such as at 0.03 to 0.2 barg, preferably between 0.06 to 0.1 barg. The temperature inside the spray column is well below the water boiling temperature, preferably between ambient temperature and 70° C., in particular between 35 and 55° C. The spray scrubber can also be operated at higher pressure (up to 2.5 barg) and at higher temperature.

Generally, the washing water can be any industrial water available at the plant. While the washing water may be any industrial water, it is useful to adjust its pH before its use in step (a). Hence, a base is added to the washing water in step (a), said base being preferably chosen among oxides and hydroxides of alkali metals and alkaline earth metals, in particular among NaOH, KOH, Ca(OH)₂ or mixtures thereof. In some embodiments, it is particularly preferred that the base is NaOH, added between 3.5% and 6.5%, preferably between 4.5% and 5.5%, above the stoichiometric amount with respect to the hydrogen cyanide and hydrogen chloride to be removed from the oxidizable combustion gas.

For plants already integrating a wet dust abatement unit to remove dust from the oxidizable combustion gas, it is particularly advantageous that the water consumption actually remains unchanged by adding the following steps to the above process:
(d) feeding the washing water from step (b) (possibly added by further water if the water used in step (a) is only a part of the whole available washing water) to the dust abatement unit to reduce dust contents of the oxidizable combustion gas upstream of the scrubber arrangement in step (a), and
(e) collecting dust abatement water from step (d) containing the dust abated in the dust abatement unit.

In still further preferred embodiments, it may be advantageous to (again) adjust the pH of the washing water from step (b) before its use in step (d). Hence, in some embodiments, a base is added to the washing water before its use in step (d), said base being preferably chosen among oxides and hydroxides of alkali metals and alkaline earth metals, in particular among NaOH, KOH, Ca(OH)₂ or mixtures thereof. In some embodiments, it is particularly preferred the base is NaOH, added to reach a pH between 9.75 and 11, nearer to 11 is preferable, which prevents the free cyanides volatilization. This (further) addition of a base is more advantageous when the content of cyanide compounds is (expected or known to be) higher than average.

Such scrubber arrangements are of particular use in the processes of the disclosure to achieve an appropriate reduction of the cyanide compounds within the oxidizable combustion gas, thereby allowing operating downstream hot stove units at higher temperatures, thus reducing the fossil energy requirements in the metallurgical reactor and hence the fossil CO₂ emissions.

The disclosure provides a second aspect of the disclosure, which proposes a process for operating a metallurgical plant, wherein an oxidizable combustion gas from a metallurgical reactor, in particular a blast furnace gas from a blast furnace, having been cleaned in a scrubber for the removal of cyanides and chlorides as described here and in a dust removal process as described herein and, is (h) fed to a hot blast stove unit and burned in said hot blast stove unit arranged for preheating blast blown into said metallurgical reactor, wherein the temperature of the burning of the cleaned oxidizable combustion gas is managed to control NOₓ emissions released to atmosphere, the preheated blast being preferably thereafter (i) injected into the metallurgical reactor, in particular the blast furnace. The control of the NOₓ emissions is enhanced by the use of the cleaned oxidizable combustion gas, in that higher burning temperatures can be used without increasing the NOₓ contents above the values obtained without cleaning and more importantly without exceeding NOₓ emission limits at the release into the atmosphere.

In other words, the second aspect of the disclosure, includes also the first aspect related to a process for cleaning an oxidizable combustion gas, which is then used in the process for operating a metallurgical plant constituting the second aspect and described in the previous paragraph.

The third aspect of the disclosure is related to the treatment of washing water for the decrease of the cyanide content after the removal of cyanide compounds from the oxidizable combustion gas. This allows avoiding the cyanide accumulation in washing water that can be so reused in the circuit with consequent reduction of used fresh water. Moreover, regulatory limits are respected in case of blowdowns.

In the context of the third aspect of the disclosure, in some embodiments, the process comprises the step of:
(f) treating the washing water from step (b) to remove cyanide compounds, in particular free cyanides.

Oxidation processes are based on the exploitation of H₂O₂ or SO₂ and air and a Cu catalyst; the oxidation process through H₂O₂ and Cu catalyst is preferred due to its lower CAPEX and OPEX as well as its easier management and greener nature.

In advantageous embodiments, the oxidation processes based on the exploitation of H₂O₂ and Cu catalyst is carried in two continuous mixed reactor arrangements in series with the biggest reactor arrangement in series to the smallest. Each reactor arrangement useable in the oxidation process of the disclosure includes a vertical tank including, an impeller unit, an impeller engine unit, a baffle unit for a better agitation and to prevent the formation of vortex, a duct for washing water feeding, said washing water feeding unit, placed near to the top of the vertical tank unit, a duct placed at the bottom of the vertical tank unit for draining the treated washing water, said washing water outlet unit, and reagents and catalyst feeding unit placed at the top of the reactor arrangement.

In some embodiments, the two reactor arrangements in series are designed such that the residence time of the washing water in the reactors is between respectively 40 and 65 minutes for the first reactor arrangement and 45 and 85 minutes for the second reactor arrangement, preferably 50 minutes for the first reactor arrangement and 60 minutes for the second reactor arrangement.

In some embodiments, H₂O₂ dosage is comprised between 0.35-0.55 g of H₂O₂ (30% wt.) per liter of washing water to be treated.

In some embodiments, Cu-based catalyst is dosed in order to have a concentration of 40 mg/L of Cu²⁺ in the washing water to be treated.

In some embodiments, pH of the washing water to be treated is preferred to be adjusted to 10 with the addition of a base (if starting pH is lower), preferably NaOH.

In some embodiments, pitched blade impellers with blade angle of 45° are preferred to guarantee a combination of radial and axial flows and higher shear levels. An impeller speed between 20 and 25 rpm is preferred.

The reactor is operated at atmospheric pressure and the temperature inside it is generally 30° C.

In further embodiments, the dust abatement water from step (e) is thereafter generally treated in a water treatment unit to separate water from the dust and to remove further contaminants. After the treatment, water is partially purged and after make-up water addition is recirculated to the gas treatment. The blowdown is preferred to be treated in step (g) to remove residual cyanides from step (e). The same oxidation process of step (f) is used or preferably activated carbon filters are exploited.

### BRIEF DESCRIPTION OF THE DRAWINGS

Preferred embodiments of the disclosure will now be described, by way of example, with reference to the accompanying drawings in which:

FIG. 1 is a cross sectional view of an embodiment of a packed scrubber arrangement useful in the present disclosure;

FIG. 2 is a cross sectional view of an embodiment of a spray scrubber arrangement useful in the present disclosure;

FIG. 3 is a cross sectional view of an embodiment of an oxidation reactor arrangement useful in the present disclosure;

FIG. 4 represents graph of some simulation data collected on the cleaning efficiency of the two scrubber arrangements.

FIG. 5 represents graph of some simulation data collected on the cleaning efficiency of the oxidation reactors.

FIG. 6 is a block schematic process flow diagram of a metallurgical plant integrating the solution as described herein.

Further details and advantages of the present disclosure will be apparent from the following detailed description of several not limiting embodiments with reference to the attached drawings.

### DESCRIPTION OF PREFERRED EMBODIMENTS

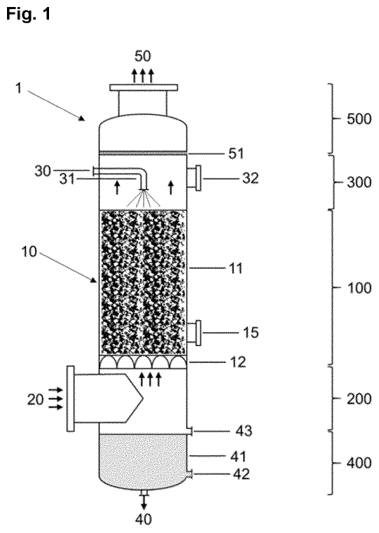

FIG. 1 shows a cross sectional view of a packed scrubber 1 useful for cleaning an oxidizable combustion gas, such as blast furnace gas. The oxidizable combustion gas enters through the inlet 20 at the bottom of the scrubber's column 10 and flows up through the packed bed 11 supported by support plate or baffle 12 towards the cleaned oxidizable combustion discharge unit at the top of column 10. The washing water enters the washing water distributor unit 300 through washing water duct 30, is distributed over the packed bed by a washing water spraying device 31 and flows by gravity in countercurrent to the oxidizable combustion gas, from top to the bottom through the packed bed 11 where the cyanide and chloride compounds are absorbed by the washing water.

The packing of the packed bed 11 can be of any known type randomly oriented (random packings) in the column 10 above the perforated support plate 12 (the packing material could be random with specific surface of 65 m²/m³ and % empty of 72%), depending on the particular operating conditions and other constraints.

The column is generally composed of a vertical cylindrical shell containing a support plate 12 for the packing material that is perforated and optionally further liquid distributing devices (not shown in FIG. 1) designed to provide still more effective irrigation of the packed bed.

Further redistributing devices, such as intermediate baffles, can be provided at one or more different height of the packed bed to redistribute the washing water forcing it to form drops and so redistribute again over the packed bed zone located underneath.

The moisture and droplets carried over by the cleaned oxidizable combustion gas are preferably removed by a mist separator 51 well known in state of art for this application so that the cleaned gas can flow via the cleaned oxidizable combustion gas discharge port 50 to the hot stove (not shown on FIG. 1) through devoted ducting.

The washing water, containing the dissolved cyanides (mostly free CN⁻) and chlorides, is drained in the washing water collecting unit 400 forming a liquid storage 41 at the bottom of the chamber 10 and delivered through drain 40 to a devoted treatment e.g. by means of pumps. The washing water collecting unit 400 preferably also integrates a pump suction 42 and an over flow orifice 43.

For installation and maintenance reasons, manholes, such as a manhole for packed bed maintenance 15 or a manhole for maintenance of the washing water spray distributor (unit) 32, are preferably provided within the shell of the chamber 10.

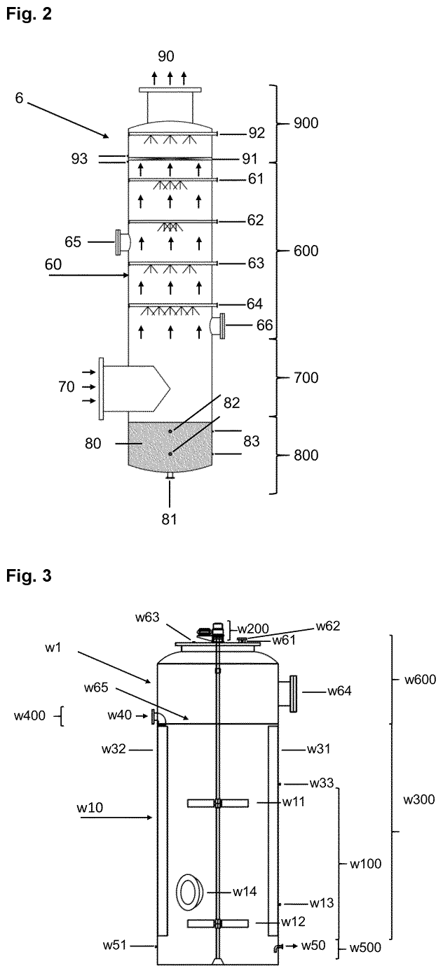

FIG. 2 shows a cross sectional view of a spray scrubber 6 useful for cleaning an oxidizable combustion gas, such as blast furnace gas. It is generally constituted of a vertical cylindrical shell.

The oxidizable combustion gas enters through the inlet 70 near to the bottom of the scrubber's column 60 and flows up through the spray section unit 30 towards the cleaned oxidizable combustion discharge unit 900 at the top of column 60.

The washing water enters through several nozzles placed on ramps that constitute the spray stages 61, 62, 63 and 64 and flows by gravity in countercurrent to the oxidizable combustion gas, from top to the bottom and the formed droplets allows the absorption of the cyanide and chloride compounds by the washing water.

The nozzles in the spray stages 61, 62, 63 and 64 are preferably axial-flow full cone nozzles to provide uniform liquid distribution over the whole circular area. Nozzles are arranged following the offset configuration in order to have a compromise between spray overlapping and water losses on the spray section unit 600 wall. The number of nozzles placed in spray stages 63 and 64 is generally higher than in spray stages 61 and 62 because of the higher proximity of spray stages 63 and 64 to the gas feeding duct which corresponds to the point of highest content of cyanide and chloride compounds in the oxidizable combustion gas.

The moisture and droplets carried over by the cleaned oxidizable combustion gas are preferably removed by a mist separator 91 well known in state of art for this application, such as Chevron type, so that the cleaned gas can flow via the cleaned oxidizable combustion gas discharge duct 90 to the hot stove (not shown on FIG. 1). Pressure drops in the demister are generally monitored for managing its cleaning and for this reason pressure losses sensor connections 93 and liquid distributors for mist separator flushing 92 are provided.

The washing water, containing the dissolved cyanides (mostly free CN⁻) and chlorides, is collected in the washing water reservoir unit 800 forming a liquid storage 80 at the bottom of the column 60 and discharged through the washing water discharge 81 to flow do a devoted treatment e.g. by means of pumps. The washing water collecting unit also integrates liquid level visual indicators 82 and liquid level sensor connections 83.

For installation and maintenance reasons, man inspection holes 65 and 66, are preferably provided within the shell of the column 60.

FIG. 3 shows a cross sectional view of a continuous mixed oxidation reactor for removing cyanide compounds, especially free cyanides, from gas washing water. It is generally constituted of a vertical tank w10.

The washing water enters through the inlet duct w40 near to the top of the reactor tank w10 and to the maximum allowed liquid level w65 (level is monitored through the sensors installed on the connections w13 and w33) and it is mixed with the reagents, such as H₂O₂ and possible antifoaming agent, and Cu-based catalyst.

The mixing is carried out through the impellers w11 and w12 that preferably are pitched blade impellers with blade angle of 45°; the impellers are activated with a dedicated engine w200. Agitation is improved and vortexes are avoided through four baffles such as the two baffles w31 and w32 depicted in FIG. 3.

The treated washing water is then drained through the drain duct w50 and send to the dust abatement unit (not showed in figure).

Possible gas and vapor are released through dedicated vent w62 placed at the top of the reactor tank w1 and in case of emergency, for instance due to increase of pressure in the reactor, safety valves w63 are provided. A pressure sensor connection w61 is provided at the top of the reactor w10. While a pH and temperature sensor connections are provided near to the bottom of the tank w10.

For installation and maintenance reasons, man inspection holes w14 and w64, are preferably provided within the shell of the tank 10.

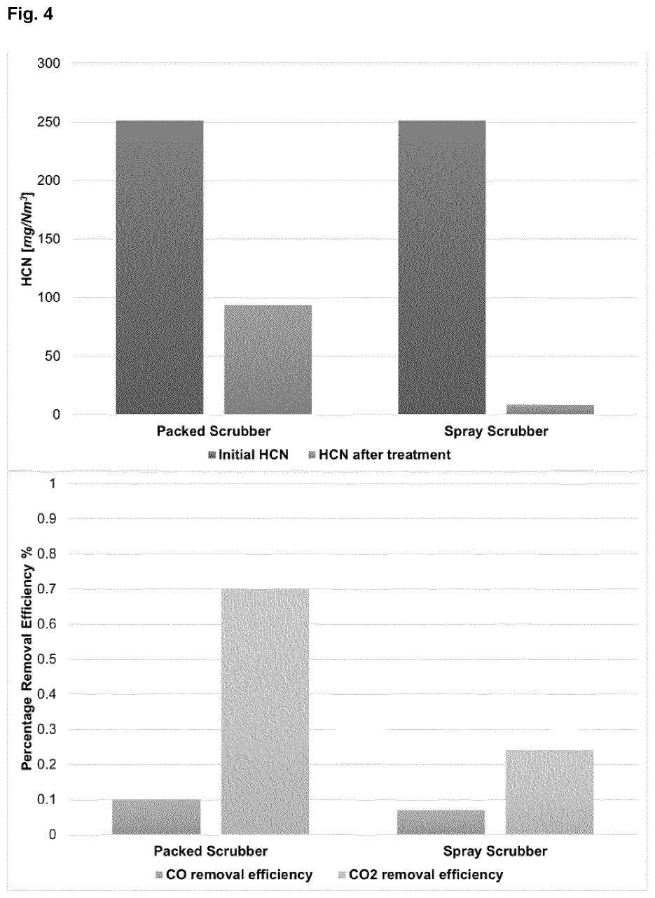

FIG. 4 illustrates the results obtained with the cleaning of a blast furnace gas through packed and spray scrubbers and by using washing water added of NaOH in an amount 5% greater than the stoichiometric amount with respect to hydrogen cyanide and hydrogen chloride to be removed.

As shown, up to 63% of HCN reduction in blast furnace gas can be reached by using packed scrubber, while up to 97% through the spray scrubber. The added amount of NaOH helps the absorption and it is sufficiently low to be selective towards cyanide and chloride compounds and to avoid the side effect of dissolving other acid components present in the blast furnace gas (e.g. CO₂ which is highly present in blast furnace gas, e.g. 20-24%). The HCN reacts with OH⁻ to form CN⁻ and H₂O. In parallel the CN-present in wastewater can also react with acidic compounds initially present in the blast furnace gas and that may have been dissolved during the wet scrubbing treatment, to form HCN. For example, this reaction can occur when the CO₂ initially present in the blast furnace gas is entrained in the washing water forming carbonic acid species, which in turn will react with cyanides to form unwanted HCN. The adjustment of the base concentration prevents other acids, such as dissolved CO₂, to react with the CN-species and again produce gaseous HCN. Therefore, the process is not only able to efficiently remove solid cyanide species, but also HCN and HCl from the blast furnace gas.

CO and CO₂ removal is respectively 0.10% and 0.70% for the packed scrubber, while 0.24% and 0.07% for the spray scrubbed, confirming the added amount of base is sufficiently low to be selective towards cyanide and chloride.

HCl removal is not shown in figure but it is almost 100% for packed scrubber and up to 96% for spray scrubber.

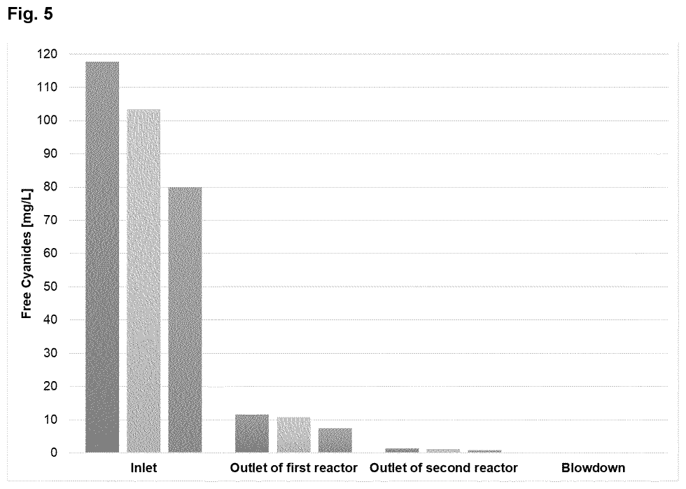

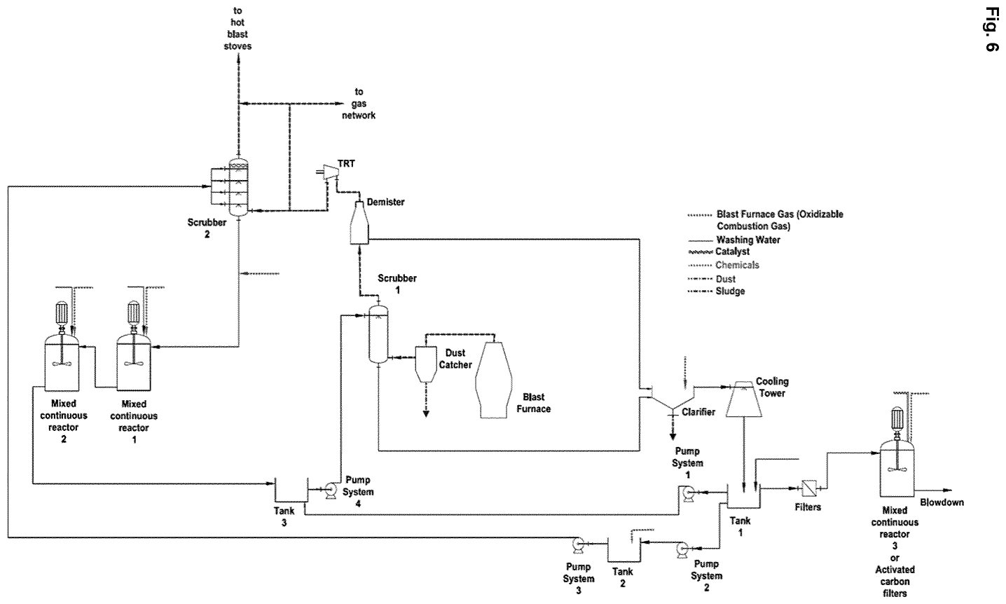

FIG. 5 shows the results obtained in the removal of free-cyanides from gas washing water in an oxidation treatment based on the use of H₂O₂ and Cu-based catalyst. Three different starting cyanides contaminations are reported as well as the behavior of its content during the different stage of the treatment. Between 89.5 and 90.7% of the initial cyanides amount is removed in the first reactor and a value below to 1.5 mg/L and 0.2 mg/L are obtained respectively after the second reactor and in the treated blowdown.

FIG. 6 depicts a process flow diagram of an embodiment of a metallurgical plant integrating the solution as described herein. Three main sections can be observed: the blast furnace that generate the blast furnace gas (oxidizable combustion gas), the gas treatment section and the washing water treatment section.

The gas treatment section includes a first area for dust removal (i.e. dust catcher, scrubber 1 and demister), a TRT for energy recovery from the expansion of the gas and the scrubber 2 that allows the removal of cyanides and chlorides as described in the present disclosure. The treated gas from scrubber 2 is then send to hot blast stoves. The pretreated gas exiting the first area after dust removal, contains cyanide and chloride species that are sent to the scrubber 2. One advantage of the first area, is that the gas sent to scrubber 2 has a lower temperature, thereby enhancing the efficiency of the cyanide and chloride removal, more specifically the removal of HCN and HCl, when treated in the scrubber 2. The cleaned treated gas may further be sent to hot blast stoves and/or to gas network to be further used as fuel gas.

The washing water treatment section is composed of the two mixed continuous reactors 1 and 2 to remove the absorbed cyanide compounds from gas washing water and of a further subsection (i.e. clarifier, cooling tower, filters) to treat the water coming from the scrubber 1; a final blowdown treatment is provided and it is constituted by a further oxidation reactor (as shown in figure) or preferably by activated carbon filters that are suitable to remove low amount of residual cyanides. The absorbed cyanide compounds are treated in the mixed continuous reactors 1 and 2 in the presence of an appropriate catalyst, such as a Cu-based catalyst, and reagents such as H₂O₂, to destroy the cyanide compounds and thereby to avoid unwanted (re) formation of HCN inside the circulating water. The treated water is further recycled/sent to scrubber 1. The resulting washing water is then advantageously treated in a clarifier to remove sludge, cooled in a cooling tower. On part is further sent back to scrubber 1 and scrubber 2, while another portion is treated in a mixed continuous reactor 3 by oxidation or by activated carbon filters.

Some tanks and pump systems are depicted in the figure to better manage the process described in the present disclosure.

1. A process for operating an oxidizable combustion gas cleaning unit in a metallurgical plant, comprising the steps of:
(a) passing an oxidizable combustion gas from a blast furnace gas from a blast furnace in a packed bed scrubber arrangement through a packed bed in countercurrent with a washing water or in a spray scrubber arrangement to remove cyanide compounds and to increase the removal of chloride compounds from said combustion gas by solubilizing said cyanide and chloride compounds in said washing water,
(b) collecting the washing water containing solubilized cyanide and chloride compounds at a bottom end of the packed bed or spray scrubber arrangement, and
(c) collecting a cleaned oxidizable combustion gas at a top of the packed bed or spray scrubber arrangement,
wherein a base is added to the washing water before step (a), said base being NaOH, which is added between 3.5% and 6.5% above the stoichiometric amount with respect to the cyanide and chloride compounds to be removed from the oxidizable combustion gas.

2. The process as claimed in claim 1, wherein the packed bed scrubber arrangement comprises, a column comprising a random packed bed unit, optionally comprising a plurality of packed bed zones separated by redistribution zones, the packed bed unit being supported by at least one perforated support plate, a washing water spray distributor arranged above said packed bed for distributing the washing water into the packed bed unit, a washing water collecting unit arranged at the bottom end of the packed bed scrubber arrangement below the packed bed, said washing water collecting unit comprising a duct for draining the washing water containing cyanide compounds from the packed scrubber arrangement, a gas feeding unit arranged for feeding the oxidizable combustion gas into the chamber below the packed bed unit, and a cleaned oxidizable combustion gas discharge unit on a top of the packed bed column comprising a duct for discharging the cleaned oxidizable combustion gas and placed after a mist eliminator.

3. The process as claimed in claim 1, wherein the washing water to oxidizable combustion gas ratio in the packed bed in step (a) is between 3.5 and 6.5 L/Nm³.

4. The process as claimed in claim 1, wherein the mean residence time of the combustion gas in the packed bed in step (a) is between 3.4 and 5.8 s.

5. The process as claimed in claim 1, wherein the packed bed has a total (wet) contact surface, comprising the total surface of the (wet) packed bed can be in contact with the oxidizable combustion gas, between 0.09 and 0.15 m²/(Nm³/h).

6. The process as claimed in claim 1, wherein the packed bed scrubber arrangement is operated at near atmospheric pressure.

7. The process as claimed in claim 1, wherein the temperature inside the packed bed is between ambient temperature and 70° C.

8. The process as claimed in claim 1, wherein the spray scrubber arrangement comprises a column comprising a spray section unit comprising at least four independent spray stages distributed along a height of the column and composed of a set of nozzle units located on multiple ramps and distributing of the washing water in the form of droplets, wherein the oxidizable combustion gas is fed through a gas feeding unit into the column below the spray section unit, wherein the washing water is collected in a washing water collecting unit arranged at a bottom end of the spray scrubber arrangement below the spray section unit and the gas feeding unit, said washing water reservoir unit comprising a duct for draining the washing water containing cyanide and chloride compounds from the spray scrubber arrangement, and wherein the cleaned oxidizable combustion gas is passed through a mist eliminator before being discharged in an oxidizable combustion gas discharge unit on a top of the spray column comprising a duct for discharging the cleaned oxidizable combustion gas.

9. The process as claimed in claim 1, wherein the flow of oxidizable combustion gas within the spray scrubber arrangement is regulated by deviating part of the flow of oxidizable combustion gas through a by-pass external to the column unit.

10. The process as claimed in claim 8, wherein the global ratio of washing water distributed in the different spray stages to oxidizable combustion gas in step (a) is between 0.8 and 2.9 L/Nm³, depending on the amount of cyanide and chloride compounds to be removed and on the desired removal and in order to manage the concentration of cyanides and chloride compounds in the washing water.

11. The process as claimed in claim 8, wherein a mean residence time of the oxidizable combustion gas in the spray section unit in step (a) is between 2 and 8 s.

12. The process as claimed in claim 8, wherein the nozzles of the spray scrubber arrangements are axial flow full cone nozzles providing droplets having a Sauter mean diameter between 1100 and 1150 μm through a proper setup of the nozzle pressure.

13. The process as claimed in claim 8, wherein the spray scrubber arrangement is operated at near atmospheric pressure.

14. The process as claimed in claim 8, wherein the temperature inside the spray column is below the water boiling temperature, between ambient temperature and 70° C.

15. The process as claimed in claim 1, comprising the further step of:
(d) feeding the washing water from step (b) to a dust abatement unit to reduce dust contents of the oxidizable combustion gas upstream of the scrubber arrangement in step (a),
(e) collecting dust abatement water from step (d) containing the dust abated in the dust abatement unit.

16. The process as claimed in claim 15, wherein a base is added to the washing water before step (d), said base being chosen among oxides and hydroxides of alkali metals and alkaline earth metals comprising NaOH, KOH, Ca(OH)₂ or mixtures thereof.

17. The process as claimed in claim 15, further comprising the step (f) of treating the washing water from step (b) to remove cyanide compounds, in particular free cyanides, and/or the step (g) for further removing residual cyanide from the blowdown of the cleaning process of dust abatement water from step (e).

18. The process as claimed in claim 1, further comprising an oxidation step for cyanide removal from washing water based on the use of H₂O₂ and a Cu catalyst, carried out in two continuously mixed reactor arrangements in series, wherein each reactor arrangement comprises a vertical tank including, an impeller unit, an impeller engine unit, a baffle unit for agitation and for preventing formation of a vortex, a duct for feeding washing water to a washing water feeding unit, placed near to the top of the vertical tank unit, a duct placed at the bottom of the vertical tank unit for draining the treated washing water, said washing water outlet unit, and reagents and catalyst feeding units placed at the top of the reactor arrangement.

19. The process as claimed in claim 18, wherein a residence time of the washing water in the continuously mixed reactor arrangements is between 40 and 65 minutes for the first reactor arrangement and 45 and 85 minutes for the second reactor arrangement.

20. The process as claimed in claim 18, wherein H₂O₂ dosage is comprised between 0.35-0.55 g of H₂O₂ (30% wt.) per liter of washing water.

21. The process as claimed in claim 18, wherein Cu-based catalyst is dosed in order to have a concentration of 40 mg/L of Cu²⁺ in the washing water.

22. The process as claimed in claim 18, wherein pitched blade impellers with blade angle of 45° are used with an impeller speed between 20 and 25 rpm.

23. The process as claimed in claim 18, wherein the reactor is operated at atmospheric pressure and at 30° C.

24. A process for operating a metallurgical plant, wherein an oxidizable combustion gas from a blast furnace gas from a blast furnace, having been cleaned by a process as claimed in claim 1, is (h) fed to a hot blast stove unit and burned in said hot blast stove unit arranged for preheating blast blown into said metallurgical reactor, wherein the temperature of the burning of the cleaned oxidizable combustion gas is managed to control NOₓ emissions released to atmosphere.

25. The process as claimed in claim 24, wherein (i) the preheated blast is injected into the metallurgical reactor.
